(19) United States
(12) Patent Application Publication
(10) Pub. No.: US 2017/0103829 A1
(43) Pub. Date: Apr. 13, 2017

(54) LIGHT STRING WITH REINFORCED WIRES

(71) Applicant: Qin Yu, Guangzhou (CN)

(72) Inventor: Qin Yu, Guangzhou (CN)

(21) Appl. No.: 14/881,186

(22) Filed: Oct. 13, 2015

(51) Int. Cl. H01B 7/18; F21S 4/10

(52) U.S. Cl. CPC H01B 7/18; F21S 4/10; F21W 2121/00

(57) ABSTRACT

The present invention provides a light string with reinforced wires. The light string includes a plurality of reinforced wires and a plurality of lamps electrically connected in series via the plurality of reinforced wires. Each reinforced wire includes a plurality of conducting wires, an outer insulating sheath covering the plurality of conducting wires and one or more reinforcing strands configured between an inner side surface and an outer side surface of the outer insulating sheath and extending along a direction parallel to a central longitudinal axis of the reinforced wire. The bending resistant performance of the electric wire between each two adjacent lamps is improved greatly, the fatigue strength of the electric wire is much better than that of an ordinary electric wire, and the tensile strength of the electric wire is improved.

### BACKGROUND OF THE INVENTION

1. Field of the Invention

The present invention relates to decorative light string, and specifically relates to a light string with reinforced wires.

2. Description of Related Art

Decorative light strings are widely used for holiday decoration. The existing decorative light sting typically includes 10 to 20 lights connected in series via a plurality of wires. To ensure safety, these wires used in the light strings should be required to meet various standards and requirements relating to both electrical and mechanical performance. For example, tensile-strength testing. To satisfy the tensile-strength testing, people usually use 22 AWG wires each of which includes 16 individual copper strands twisted together and covered with an insulating sheath to form a “twisted-pair” light string. In detail, a section of wire without a light connected on is twisted along the length of the light string. As such, if opposing forces were applied to the light string, the twisted pairs of wires are stronger than single 22 AWG wires, and can satisfy the tensile-strength testing. However, this will lead a waste of the section of wire, drive up material cost and make the light strings heavier and bulkier.

China Utility Patent No. 201220025161.2 (filed at Jan. 19, 2012) discloses a high tensile-strength and wear-resistant electric cable including an internally-reinforced cable core. The internally-reinforced cable core includes several conductor strands, one or more Kevlar fiber ropes and an insulating layer enveloping the conductor strands and the one or more Kevlar fiber ropes.

U.S. Pat. Pub. No. US2015/0167944 (filed at Jul. 10, 2014, and claims the benefit of U.S. Provisional Application No. 61/877,854 filed Sep. 13, 2013) discloses a decorative lighting with reinforced wiring which has internally-reinforced wires the same as the internally-reinforced cable core of CN201220025161.2. The internally-reinforced wire includes one or more reinforcing strands or threads including polymer material, one or more conductor strands, and insulating layer or jacket enveloping the conductor strands and the reinforcing strands.

The above mentioned internally-reinforced cable core and internally-reinforced wire used for decorative lighting can satisfied the tensile-strength testing, thus the section of wire without a light connected on need not to be twisted along the length of the light string.

However, there is also a need to provide other reinforced wires for use in light strings.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is a perspective view of a light string with reinforced wires; and

FIG. 2 is a cross-sectional view of an reinforced wire in accordance with an embodiment of the present invention.

### DETAILED DESCRIPTION OF THE INVENTION

The invention will now be described in detail through several embodiments with reference to the accompanying drawings.

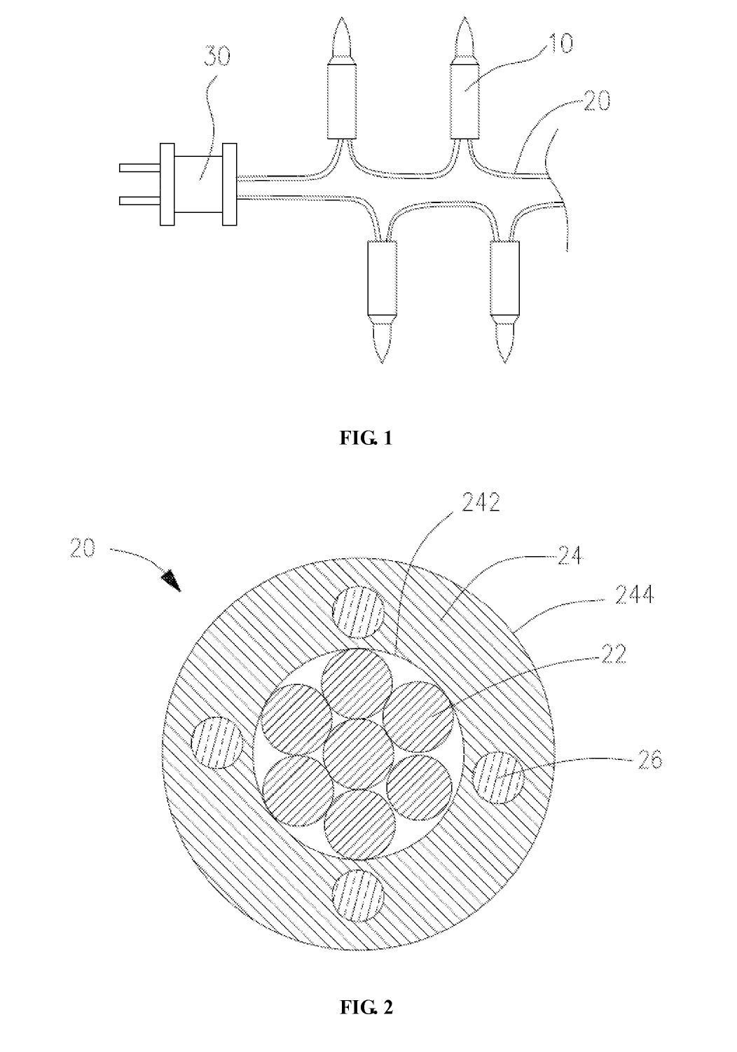

Please referring to FIG. 1, a light string with reinforced wires 20 is illustrated. The light string includes a power plug 30 and eight to twenty lamp assemblies 10 connected in series via the reinforced wires 20. Connecting wires which are used to connect two lamp assemblies 10 and the power plug 30 can be ordinary, non-reinforced conducting wires or the reinforced wires 20.

Please also referring to FIG. 2, in an embodiment, take a 22 AWG wire for example, the reinforced wire 20 includes sixteen conducting wires (lead, in other words, usually including copper material primarily) 22 twisted together, and an outer insulating sheath 24 covering the conducting wires 22. The outer insulating sheath 24 has an inner side surface 242 and an outer side surface 244. Four reinforcing strands 26 are uniformly distributed between the inner side surface 242 and the outer side surface 244 in a peripheral direction of the outer insulating sheath 24. The four reinforcing strands 26 extend along a direction parallel to a central longitudinal axis of the reinforced wire 20 to enhance a tensile-strength of the reinforced wire 20. The outer insulating sheath 24 maybe made of PVC, and the reinforcing strands 26 include a polymer material, such as PE, PET, and so on. The four reinforcing strands 26 together can exhibit tensile strength ranging from 45 to 65 Mpa, as such, the reinforced wire 20 can bear a 56 Mpa tension.

Understandably, in other embodiments, the number of the reinforcing strands 26 can be one or two or three or more than four, as long as the reinforcing strands can exhibit tensile strength ranging from 45 to 65 Mpa or 65 to 85 Mpa.

For the light string with the reinforced wires, the reinforcing strands are provided within the outer insulating sheath, so that the bending resistant performance of the electric wire between each two adjacent lamps is improved greatly, the fatigue strength of the electric wire is much better than that of an ordinary electric wire, and the tensile strength of the electric wire is improved. By using the light string with reinforced wires, a tree can be tied by using only one electric wire, thereby saving purchasing cost and tree tying time and being conductive to improving the market competitiveness of the novel Christmas light string.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A light string with reinforced wires, comprising:
a plurality of reinforced wires; and
a plurality of lamps electrically connected in series via the plurality of reinforced wires;
wherein each reinforced wire comprises:
a plurality of conducting wires;
an outer insulating sheath covering the plurality of conducting wires, the outer insulating sheath comprising an inner side surface and an outer side surface; and
one or more reinforcing strands configured between the inner side surface and the outer side surface of the outer insulating sheath and extending along a direction parallel to a central longitudinal axis of the reinforced wire.

2. The light string with reinforced wires of claim 1, wherein the one or more reinforcing strands comprise a polymer material.

3. The light string with reinforced wires of claim 1, wherein the one or more reinforcing strands exhibit tensile strength ranging from 45 to 65 MPa.
